(19) United States
(12) Patent Application Publication
(10) Pub. No.: US 2026/0056988 A1
(43) Pub. Date: Feb. 26, 2026

(54) INFORMATION RETRIEVAL SYSTEM

(71) Applicant: KYOCERA Document Solutions Inc., Osaka (JP)

(72) Inventor: Kunihiko Tanaka, Osaka (JP)

(21) Appl. No.: 19/296,257

(22) Filed: Aug. 11, 2025

(30) Foreign Application Priority Data
Aug. 22, 2024 (JP) 2024-140623

(51) Int. Cl. G06F 16/3329; G06F 16/334

(52) U.S. Cl. CPC G06F 16/33295; G06F 16/3347

(57) ABSTRACT

This information retrieval system provides an answer corresponding to a question using a large language model. A context information retrieving unit retrieves a document database with a characteristic vector of the question and thereby acquires as context information a text group that a similarity level between the characteristic vector and a characteristic vector of the text group satisfies a predetermined condition. In the document database, character vectors and page numbers of text groups obtained by dividing a document are registered. A prompt generating unit generates a prompt that includes the question and the context information. An answer acquiring unit acquires an answer corresponding to the prompt using a large language model. An answer outputting unit outputs as an answer corresponding to the question the context information and a page number associated with the context information together with the answer corresponding to the prompt.

### CROSS-REFERENCE TO RELATED APPLICATIONS

This application relates to and claims priority rights from Japanese Patent Application No. 2024-140623, filed on August 22nd, 2024, the entire disclosures of which are hereby incorporated by reference herein.

### BACKGROUND

### 1. Field of the Present Disclosure The present disclosure relates to an information retrieval system.

### 2. Description of the Related Art

Recently, large language models (LLMs) such as GPT of OpenAI and PaLM2 of Google have been put into practical use, and such LLMs are enabled to process a task such as question-and-answer session in a natural language.

A text generating apparatus (a) generates another question text corresponding to an inputted question text on the basis of question generation examples and a conversation history, (b) calculates a characteristic vector of a text generated from the original question text and the generated other question text, (c) acquires a text having a high similarity from a database on the basis of the characteristic vector, and (d) adds as reference information to the original question text an additional text generated from the acquired text and thereby generates a prompt to be inputted to an LLM.

However, the aforementioned LLMs have a problem called “hallucination”, and an improper answer (untrue answer, answer based on a fictional fact, or the like) may be generated. Some users may believe that such improper answer is a proper answer.

### SUMMARY

An information retrieval system according to an aspect of the present disclosure is an information retrieval system that provides an answer corresponding to a question using a large language model, includes a question receiving unit, a context information retrieving unit, a prompt generating unit, an answer acquiring unit, and an answer outputting unit. The question receiving unit is configured to receive the question. The context information retrieving unit is configured to retrieve a document database with a characteristic vector of the question and thereby acquire as context information a text group that a similarity level between the characteristic vector and a characteristic vector of the text group satisfies a predetermined condition, the document database in which text groups obtained by dividing a document, character vectors of the text groups and page numbers of the text groups are registered such that the text groups, the characteristic vectors, and page numbers are associated with each other. The prompt generating unit is configured to generate a prompt that includes the question and the context information. The answer acquiring unit is configured to acquire an answer corresponding to the prompt using a large language model. The answer outputting unit is configured to output as an answer corresponding to the question the context information and a page number associated with the context information together with the answer corresponding to the prompt.

These and other objects, features and advantages of the present disclosure will become more apparent upon reading of the following detailed description along with the accompanied drawings.

### BRIEF DESCRIPTION OF THE DRAWINGS

FIG. 1 shows a block diagram that indicates an information retrieval system according to an embodiment of the present disclosure;

FIG. 2 shows a diagram that indicates an example of a document;

FIG. 3 shows a diagram that explains text groups extracted from the document shown in FIG. 2 in Embodiment 1;

FIG. 4 shows a diagram that explains a relationship between the text groups shown in FIG. 3 and page numbers;

FIG. 5 shows a diagram that indicates an example of a template for a prompt;

FIG. 6 shows a diagram that indicates an example of an answer to a question;

FIG. 7 shows a flowchart that explains registration of a document in the information retrieval system shown in FIG. 1;

FIG. 8 shows a flowchart that explains information retrieving in the information retrieval system shown in FIG. 1; and

FIG. 9 shows a diagram that explains registration of a document in Embodiment 2.

### DETAILED DESCRIPTION

Hereinafter, embodiments according to an aspect of the present disclosure will be explained with reference to drawings.

### Embodiment 1

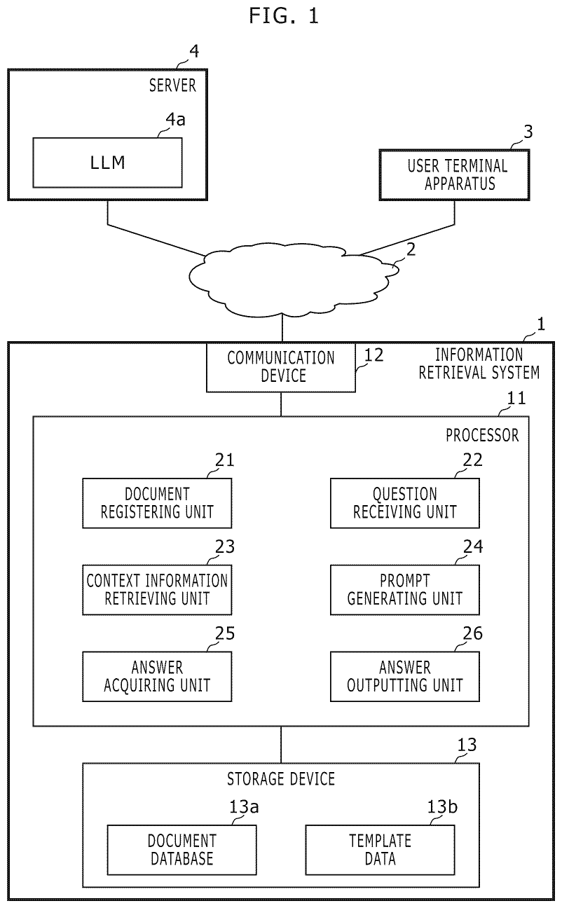

FIG. 1 shows a block diagram that indicates an information retrieval system according to an embodiment of the present disclosure. The information retrieval system 1 shown in FIG. 1 is an information retrieval system that provides an answer corresponding to a question using a large language model 4a, and includes a processor 11 as a computer, a communication device 12, and a storage device 13. Here, the information retrieval system 1 is installed in a single computer device, and alternatively, may be dispersedly installed in plural computer devices.

The communication device 12 is a device (network interface or the like) capable of data communication with another device (here the user terminal apparatus 3, the server 4 and the like) through the computer network 2 such as Internet or intranet. The user terminal apparatus 3 is a device capable of network communication, that a user operates, such as personal computer or smart phone. The server 4 includes the large language model 4a, receives a prompt, and upon receiving the prompt, generates an answer corresponding to the prompt using the large language model 4a, and transmits the answer as a response to the prompt.

The storage device 13 is a nonvolatile storage device such as flash memory or hard disk and stores a program and data. In the storage device 13, a document database 13a and template data 13b mentioned below have been stored.

Here, the processor 11 executes a program stored in the storage device 13, and thereby acts as a document registering unit 21, a question receiving unit 22, a context information retrieving unit 23, a prompt generating unit 24, an answer acquiring unit 25, and an answer outputting unit 26.

In the aforementioned document database 13a, registered are a text group obtained by dividing a document, a characteristic vector of this text group, and a page number of this text group that are associated with each other. The document may be a specific document in an organization such as company rules, or may be a publicly-available document.

The document registering unit 21 registers a document specified by a user into the document database 13a. Specifically, the document registering unit 21 (a) divides the aforementioned document and thereby generates the text group, (b) determines a page number of the text group on the basis of the document, (c) derives a characteristic vector of the text group, and (d) registers the generated text group, the determined page number, and the derived characteristic vector to the document database so as to associate text group, the page number, and the characteristic vector with each other. The characteristic vector is generated from the text group using an existing embedding process.

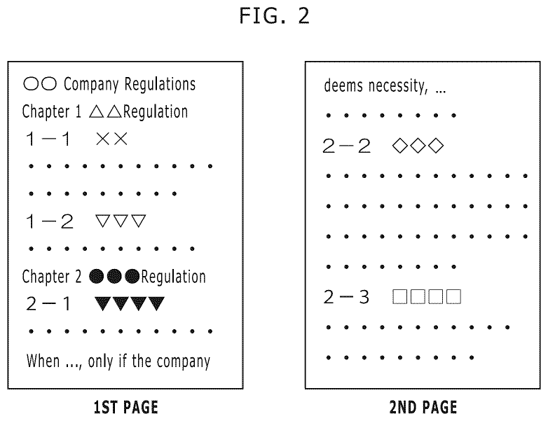

FIG. 2 shows a diagram that indicates an example of a document. For example, the document is a structured file such as PDF (Portable Document Format) file that includes a text of each page, and from the structured file, a text and a page number of each page are extracted in accordance with an existing method.

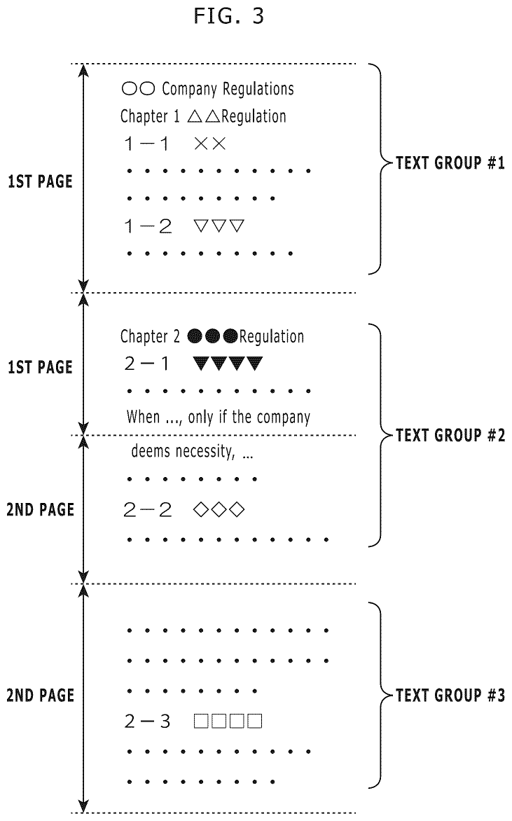

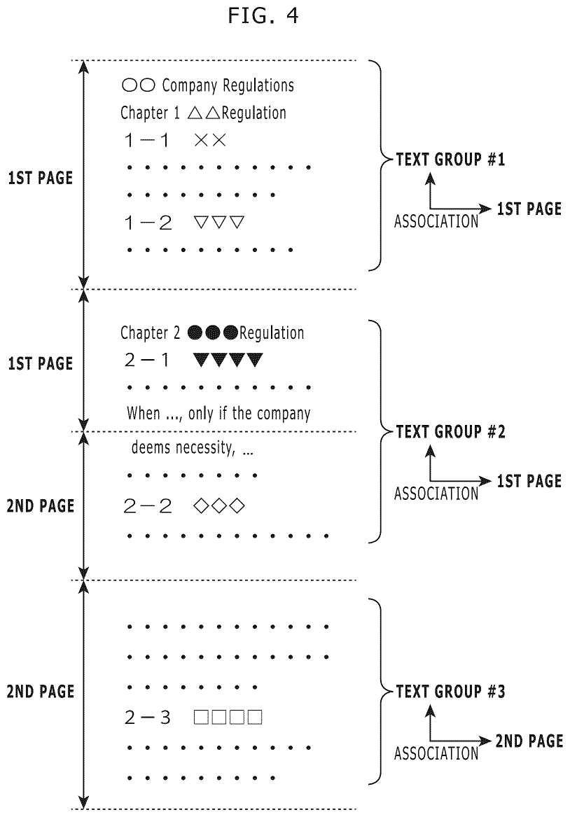

FIG. 3 shows a diagram that explains text groups extracted from the document shown in FIG. 2 in Embodiment 1. FIG. 4 shows a diagram that explains a relationship between the text groups shown in FIG. 3 and page numbers.

The document registering unit 21 divides a document into predetermined character number (e.g. 1000 characters) increments as shown in FIG. 3 and thereby generates text groups #1 to #n, and as shown in FIG. 4, for example, determines a page number corresponding to each text group #i, and registers the text group, the page number and the characteristic vector into the document database 13a so as to associate them with each other.

Here, regarding a text group over two pages such as the text group #2 in FIG. 3, for example, a page number of a page to which a head part of the text group belongs is determined as the page number corresponding to the text group as shown in FIG. 4, for example.

The question receiving unit 22 receives a question. Specifically, the question receiving unit 22 receives a question text (text data) transmitted from the user terminal apparatus 3 using the communication device 12.

The context information retrieving unit 23 retrieves the document database 13a with a characteristic vector of the received question, and thereby acquires as context information a text group (text data) of which a similarity level (cosine similarity level) between characteristic vectors of the both satisfies a predetermined condition.

The prompt generating unit 24 generates a prompt that includes the aforementioned question and the aforementioned context information. Specifically, the prompt generating unit 24 (a) refers to the template data 13b and thereby acquires a template (text data) for a prompt, and (b) inserts the aforementioned question and the aforementioned context information to the template and thereby generates a prompt.

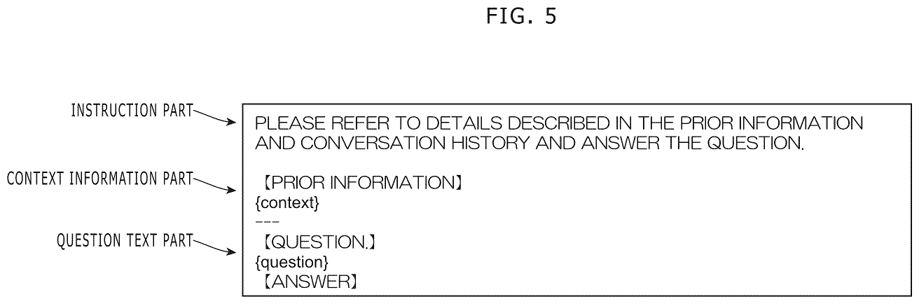

FIG. 5 shows a diagram that indicates an example of a template for a prompt. The prompt includes an instruction part, a context information part, and a question text part. The instruction part is a text that indicates an instruction to the large language model 4a, the context information part is a part in which the aforementioned context information is described, and in the template, the context information part includes a parameter “{context}” to be replaced with the context information. The question text part is a part in which the aforementioned question is described, and in the template, the question text part includes a parameter “{question}” to be replaced with the question.

The answer acquiring unit 25 acquires an answer corresponding to the prompt using the large language model 4a. Specifically, using the communication device 12, the answer acquiring unit 25 transmits the prompt to the server 4 of the large language model 4a, and receives an answer corresponding to the prompt from the server 4.

The answer outputting unit 26 outputs as an answer corresponding to the aforementioned question the context information and a page number associated with the context information together with the answer corresponding to the prompt. It should be noted that the aforementioned answer of the question is transmitted by the answer outputting unit 26 using the communication device 12 to the user terminal apparatus 3, and displayed to a user by the user terminal apparatus 3.

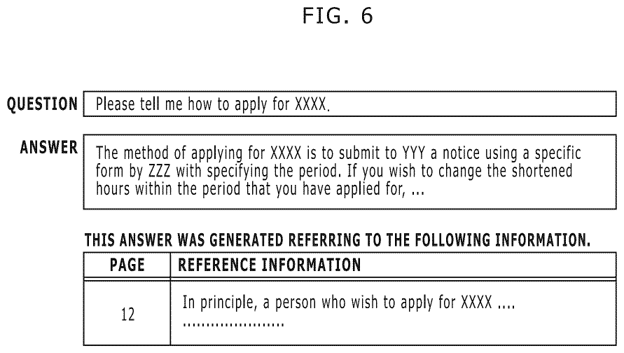

FIG. 6 shows a diagram that indicates an example of an answer to a question. For example, as shown in FIG. 6, the answer outputting unit 26 displays as the answer corresponding to the aforementioned question the answer corresponding to the prompt, the aforementioned context information (“REFERENCE INFORMATION” in FIG. 6), and the aforementioned page number (“PAGE” in FIG. 6) in a single screen on a predetermined display device (display device of the user terminal apparatus 3) to a user.

The following part explains a behavior of the image processing system in Embodiment 1.
(a) Registration of a Document

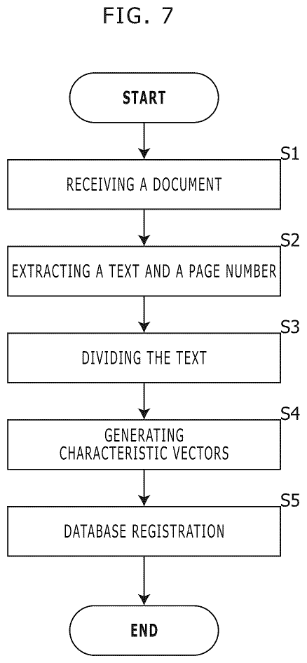

FIG. 7 shows a flowchart that explains registration of a document in the information retrieval system shown in FIG. 1.

When receiving a document (PDF file or the like) with a document registration request (in Step S1), the document registering unit 21 extracts a text and a page number of each page from the document (in Step S2), divides the texts of a series of the pages and thereby generates text groups (in Step S3), derives characteristic vectors of the generated text groups (in Step S4), and registers the text group, the determined page number, and the derived characteristic vector into the document database 13a for each of the generated text groups so as to associate the text group, the page number, and the characteristic vector with each other (in Step S5).
(b) Information Retrieving

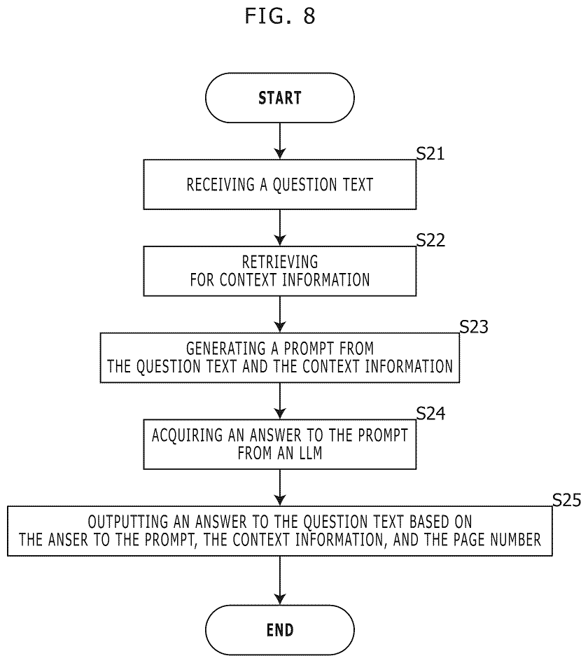

FIG. 8 shows a flowchart that explains information retrieving in the information retrieval system shown in FIG. 1.

When the question receiving unit 22 receives a question (in Step S21), the context information retrieving unit 23 derives a characteristic vector of the question, and retrieves the document database 13a with the characteristic vector and thereby acquires the corresponding context information and the corresponding page number (in Step S22).

Subsequently, the prompt generating unit 24 generates a prompt that includes the aforementioned question and the aforementioned context information (in Step S23), and the answer acquiring unit 25 acquires an answer corresponding to the prompt using the large language model 4a (in Step S24).

The answer outputting unit 26 outputs as an answer corresponding to the question the answer corresponding to the prompt with the aforementioned context information and the aforementioned page number (in Step S25).

As mentioned, in the aforementioned Embodiment 1, the context information retrieving unit 23 retrieves with a characteristic vector of a question the document database 13a in which text groups obtained by dividing a document, character vectors of the text groups, and page numbers of the text groups are registered such that the text groups, the characteristic vectors, and page numbers are associated with each other, and thereby acquires as context information a text group that a similarity level between the characteristic vector and a characteristic vector of the text group satisfies a predetermined condition. The prompt generating unit 24 generates a prompt that includes the question and the context information, and the answer acquiring unit 25 acquires an answer corresponding to the prompt using the large language model 4a. The answer outputting unit 26 outputs as an answer corresponding to the aforementioned question the context information and a page number associated with the context information together with the answer corresponding to the prompt.

Consequently, a user refers to not only the answer corresponding to the prompt but the context information and the page number and thereby the user can determine validity of the answer from the large language model for a question from the user. Specifically, the user refers to the indicated context information and therewith properly determines the validity and refers to a page of the indicated page number in the original document and therewith more properly determines the validity.

### Embodiment 2

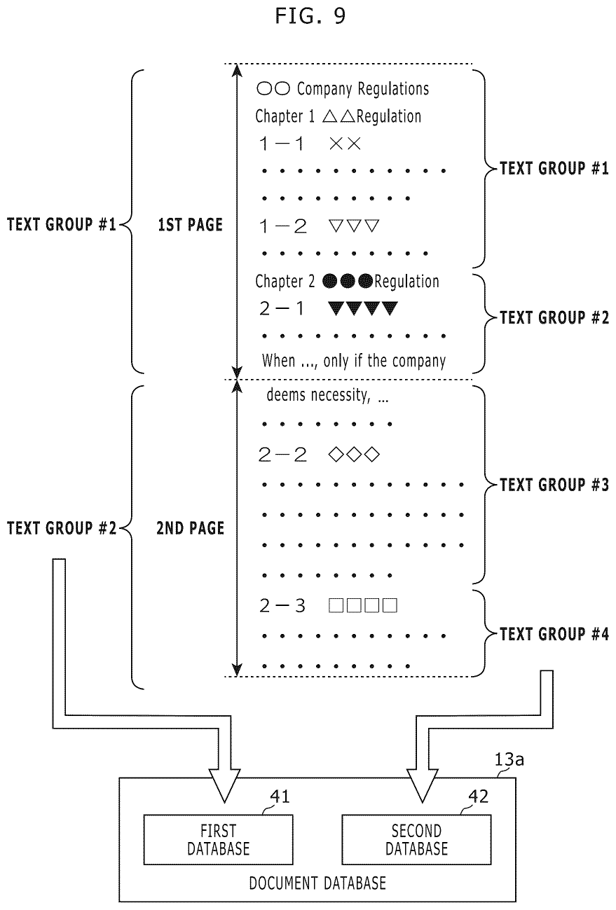

FIG. 9 shows a diagram that explains registration of a document in Embodiment 2.

In Embodiment 2, as shown in FIG. 9, for example, the document database 13a includes a first database 41 and a second database 42.

In the first database 41, text groups obtained by dividing the document page by page, characteristic vectors of these text groups, and page numbers of the text groups are registered so as to associate these text groups, these characteristic vectors, and these page numbers with each other, respectively.

In the second database 42, text groups obtained by dividing each page of the document such that each of the text groups has a predetermined number of characters, and characteristic vectors of these text groups are registered so as to associate these text groups and these characteristic vectors with each other, respectively.

Therefore, for a specified document, the document registering unit 21 (a) derives text groups obtained by dividing the document page by page, characteristic vectors and registers them into the first database 41, and (b) derives text groups obtained by dividing each page of the document such that each of the text groups has a predetermined number of characters (e.g. 1000 characters), and characteristic vectors of these text groups and registers them into the second database 42. Among the text groups obtained by dividing each page of the document such that each of the text groups has a predetermined number of characters, a number of characters in a text group of a page end part may be less than the predetermined number.

Further, in Embodiment 2, the context information retrieving unit 23 retrieves the second database 42 with a characteristic vector of the question and thereby acquires as context information a text group that a similarity level between the characteristic vector and a characteristic vector of the text group satisfies a predetermined condition.

Furthermore, a page number for the answer corresponding to the question is determined on the basis of the first database 41. Here, the context information retrieving unit 23 or the answer outputting unit 26 retrieves the first database 41 with the characteristic vector of the text group acquired as the context information, and acquires as the page number for the answer corresponding to the question a page number associated with the text group that the similarity level satisfies the predetermined condition.

Thus, the first database 41 is a database to determine the page number for the answer corresponding to the question, and the second database 42 is a database to determine a text group corresponding to the question (i.e. context information).

Other parts of the configuration and behaviors of the information retrieval system in Embodiment 2 are identical or similar to those in Embodiment 1, and therefore not explained here.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

For example, in the aforementioned embodiments, a document name may be acquired on the basis of a file name of a data file of the document or a user input; the text group extracted from the document, the characteristic vector, the page number, the document name and the like may be registered into the document database 13a so as to associate the text group with the characteristic vector, the page number, and the document name; and when outputting the answer, the corresponding document name may be output with the page number.

What is claimed is:

1. An information retrieval system that provides an answer corresponding to a question using a large language model, comprising:
a question receiving unit configured to receive the question;
a context information retrieving unit configured to retrieve a document database with a characteristic vector of the question and thereby acquire as context information a text group that a similarity level between the characteristic vector and a characteristic vector of the text group satisfies a predetermined condition, the document database in which text groups obtained by dividing a document, character vectors of the text groups and page numbers of the text groups are registered such that the text groups, the characteristic vectors, and page numbers are associated with each other;
a prompt generating unit configured to generate a prompt that includes the question and the context information;
an answer acquiring unit configured to acquire an answer corresponding to the prompt using a large language model; and
an answer outputting unit configured to output as an answer corresponding to the question the context information and a page number associated with the context information together with the answer corresponding to the prompt.

2. The information retrieval system according to claim 1, further comprising a document registering unit configured to (a) divide the document and thereby generate the text group, (b) determine a page number of the text group on the basis of the document, (c) derive a characteristic vector of the text group, and (d) register the generated text group, the determined page number, and the derived characteristic vector to the document database so as to associate text group, the page number, and the characteristic vector with each other.

3. The information retrieval system according to claim 1, wherein the document database comprises a first database, and a second database, in the first database, text groups obtained by dividing the document page by page, characteristic vectors of these text groups, and page numbers of the text groups are registered so as to associate these text groups, these characteristic vectors, and these page numbers with each other, respectively, and in the second database, text groups obtained by dividing each page of the document such that each of the text groups has a predetermined number of characters, and characteristic vectors of these text groups are registered so as to associate these text groups and these characteristic vectors with each other, respectively ;
the context information retrieving unit retrieves the second database with a characteristic vector of the question and thereby acquires the context information a text group of which a similarity level to this characteristic vector satisfies a predetermined condition; and
the page number is determined on the basis of the first database.

4. The information retrieval system according to claim 1, wherein the answer outputting unit displays as an answer corresponding to the question the context information and the page number associated with the context information in a single screen on a predetermined display device so as to associate the context information and the page number with each other.
